(19) United States
(12) Patent Application Publication
(10) Pub. No.: US 2025/0220041 A1
(43) Pub. Date: Jul. 3, 2025

(54) TRANSPARENT PROXY MODE AUTHENTICATION IN DNS DDOS MITIGATION

(71) Applicant: Fortinet, Inc., Sunnyvale, CA (US)

(72) Inventor: Pengfei Hu, Los Gatos, CA (US)

(73) Assignee: Fortinet, Inc., Sunnyvale, CA (US)

(21) Appl. No.: 18/401,570

(22) Filed: Dec. 31, 2023

(51) Int. Cl. H04L 9/40

(52) U.S. Cl. CPC H04L 63/1458; H04L 63/20

(57) ABSTRACT

A UDP DNS query from a client, and validated by a transparent proxy prior to prevent DDOS attacks. In more detail, the client is challenged by sending back a DNS response with a Truncated (TC) bit set to 1. Responsive to the client sending back a TCP SYN frame, an attempt is made to establish a TCP connection with the client from the transparent DNS proxy. Responsive to a successful TCP connection, the UDP DNS query is forwarded from the transparent DNS proxy to the DNS resolver on behalf of the client. Responsive to receiving a DNS response from the DNS resolver, the UDP DNS response is converted to a TCP response forwarded to the client. The TCP connection can then be closed.

### FIELD OF THE INVENTION

The invention relates generally to computer networks, and more specifically, for transparently protecting against denial-of-service (DDOS) attacks on a Domain Name Server (DNS) resolver from a client.

### BACKGROUND

A DDOS is a malicious attempt to disrupt normal traffic to a target by flooding it with disrupting traffic. Source IP address authentication is an important component of anti-DDOS product, for DNS source authentication it not only authenticates the client source IP address is real and active (L4) but also authenticate the L7 activity of the client's DNS stack.

Currently there are mainly three types of source authentication methods implemented by industry players for DNS anti-DDOS: 1) Passive User Datagram Protocol (UDP) mode-Drop the first DNS query (UDP/53) and wait until client retransmit another DNS query within a timeout period. 2) Active UDP mode—Only can be used for protecting authoritative DNS server. By sending a ns referral (or cname) to client (recursive servers) to redirect resolver's following DNS queries and when anti-DDOS product observe this challenged response from client the client's src IP is authenticated successfully. 3) Active TCP mode-Make use of “Truncate” bit of DNS protocol, when receive UDP DNS request from client, anti-DDOS product replies DNS response with TC bit set to force client to resend its DNS request over TCP, and when anti-DDOS node observes the resent DNS request on TCP then the source address of client is authenticated.

Each of the above measures have its drawback or restrictions: For passive UDP mode, it is not a reliable method and easy to be bypassed by attacker; attacker just need to forge DNS queries and send them multiple times to bypass this method; For active UDP mode, the drawbacks are: it is only worked for authoritative DNS server, no matter making use of ns referral or cname method, if there are multiple NS candidates known at client side, it has the risk that the anti-DDOS product cannot receive its challenge response back to it, and failed to recognize the real resolver client, and may block the normal DNS queries from real resolver.

What is needed is a robust technique for protecting against DDOS attacks on a DNS resolver from a client without notification to the DNS resolver or to the client.

### SUMMARY

To meet the above-described needs, methods, computer program products, and systems for transparently protecting against DDOS attacks on a DNS resolver from a client.

In one embodiment, a UDP DNS query from a client, and validated by a transparent proxy prior to prevent DDOS attacks. In more detail, the client is challenged by sending back a DNS response with a Truncated (TC) bit set to 1. Responsive to the client sending back a TCP SYN frame, an attempt is made to establish a TCP connection with the client from the transparent DNS proxy.

In another embodiment, responsive to a successful TCP connection, the UDP DNS query is forwarded from the transparent DNS proxy to the DNS resolver on behalf of the client. Responsive to receiving a DNS response from the DNS resolver, the UDP DNS response is converted to a TCP response forwarded to the client. The TCP connection can then be closed.

Advantageously, computer networks are improved with better performing network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1A is a high-level block diagram illustrating aspects of a system coordinating for protecting against DDOS attacks on a DNS resolver from a client without notification to the DNS resolver to the client, during loading balancing, utilizing TOS in SD-WAN, according to some embodiments.

FIG. 1B is a high-level block diagram illustrating a DDOS mitigation network appliance as a transparent proxy to a DNS resolver, according to an embodiment.

FIG. 1C is a more detailed block diagram illustrating the DDOS mitigation network appliance, according to an embodiment.

FIG. 1D is a block diagram illustrating an example computing device for the system of FIG. 1, according to one embodiment.

FIG. 2A is a high-level flow diagram illustrating a method for protecting against DDOS attacks on a DNS resolver from a client without notification to the DNS resolver to the client, according to an embodiment.

FIG. 2B is a more detailed flow diagram illustrating a step for finishing TCP handshake, from the method of FIG. 2, according to one embodiment.

FIG. 2C is a more detailed flow diagram illustrating a step for performing standard a UDP DNS request, from the method of FIG. 2, according to one embodiment.

FIG. 2D is a more detailed flow diagram illustrating a step for updating DNS requester and close a UDP or TCP session, from the method of FIG. 2, according to one embodiment.

FIG. 3A is a high-level flow diagram of a method for load balancing data traffic, according to an embodiment.

FIG. 3B is a more detailed flow diagram detailing a step of per-application SD-WAN path selection, during loading balancing, utilizing TOS, according to an embodiment.

### DETAILED DESCRIPTION

Methods, computer program products, and systems for protecting against DDOS attacks on a DNS resolver from a client without notification to the DNS resolver to the client. The following disclosure is limited only for the purpose of conciseness, as one of ordinary skill in the art will recognize additional embodiments given the ones described herein.

### I. Systems for Transparent Proxy DDOS Mitigation

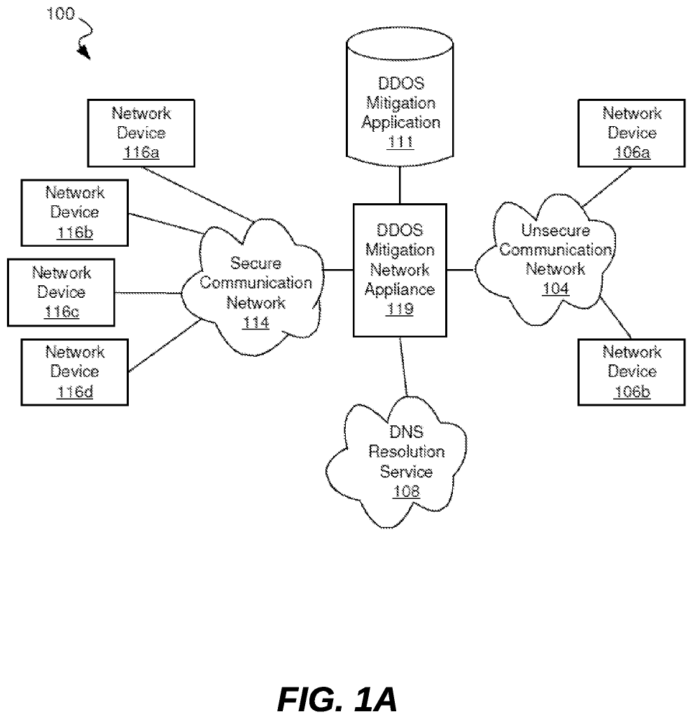

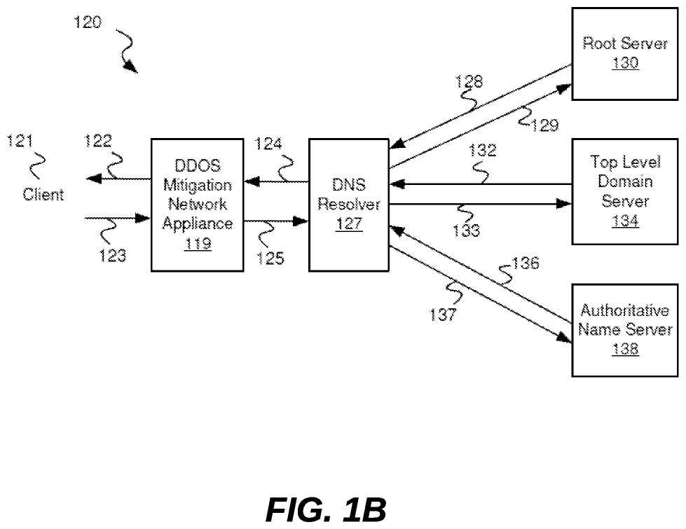

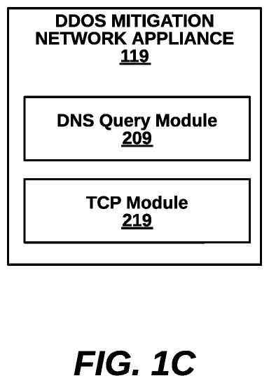

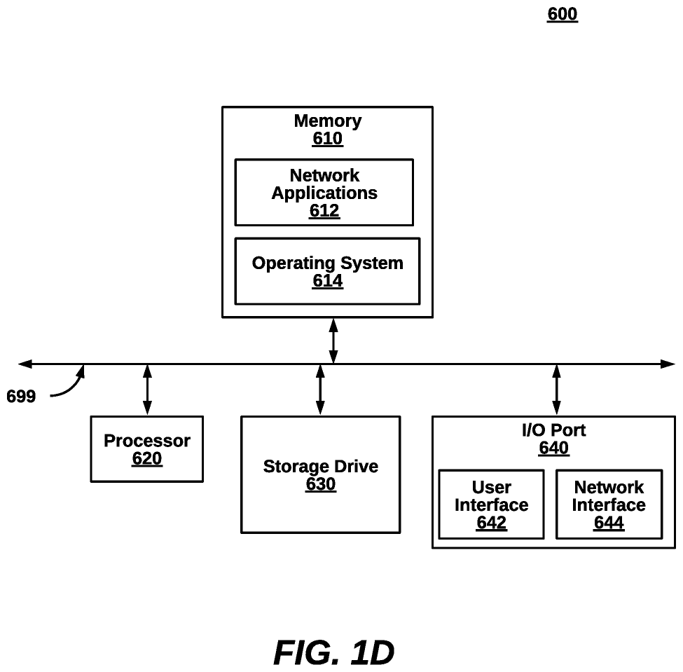

FIG. 1 is a high-level block diagrams illustrating a system 100 for transparently protecting against DDOS attacks on a DNS resolver from a client, according to an embodiment. The system 100 includes an enterprise network with a Wi-Fi gateway 110, an SD-WAN server 120, and a station 130. An ISP 1 140A, an ISP 2 140B, and an ISP 3 140C are outside of the enterprise network. Destinations for traffic may also exist outside of the enterprise network. Other embodiments of the system 100 can include additional components that are not shown in FIG. 1, such as routers, switches, network gateways, and firewalls, as well as additional access points and stations are also possible. For example, the system 100 of FIG. 1 shows one station and three access points, however, other examples have hundreds of stations connected to access points distributed over different LANs. The components of system 100 can be implemented in hardware, software, or a combination of both. An example implementation is shown in FIG. 6.

In one embodiment, the components of the system 100 are coupled in communication over a private network connected to a public network, such as the Internet. In another embodiment, system 100 is an isolated, private network, or alternatively, a set of geographically dispersed LANs. The components can be connected to the data communication system 199 via hard wire (e.g., Wi-Fi gateway 110, SD-WAN server and ISP 1 140A, ISP 2 140B, and ISP 3 140C). The components can also be connected via wireless networking (e.g., station 130). The data communication network 199 can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802, 11r, 802.11be, Wi-Fi 6, Wi-Fi 6E, Wi-Fi 7 and the like. Components can use IPV4 or Ipv6 address spaces.

One embodiment of the system 100 in operation is described in the following non-limiting example:

A transparent proxy mode source authentication mechanism is a reliable, effective DNS source authentication method which can be applied to against the scripted DNS attack from botnet using real IP host or spoofed. Compared with other currently known industry implements, this is effective for protecting either authoritative DNS server or recursive DNS server, and is very easy to use, no any configuration requirement or deployment dependency for DNS server side.

The DNS recursive resolver 127 plays as a DNS gateway, usually client side will send its DNS query to a recursive resolver, not directly to the authoritative name server. ISP usually will provide the DNS resolver 127. The DNS resolver 127 runs on the recursive mode just as showed in above picture.

The authoritative DNS server 138 is the server who hosts the domains. For example, when user asks domain www.google.com, the DNS query will be sent to the DNS recursive resolver 127. And the DNS resolver 127 will do a recursive search until it gets the answers (IP addresses for www.google.com) and send back to user. In this procedure, the DNS resolver 127 first asks the root server “who knows the zone of ‘com’, and root server will tell DNS resolver 127 the TLD (Top Level DNS) server 134 list. And then DNS resolver 127 asks “who hosts the zone of ‘google.com’”, and TLD server 134 will send back the authoritative DNS server 138 list. And DNS resolver 127 asks the authoritative DNS server 138 “what is the IP address of ‘www.google.com’”, and authoritative server 138 will give the answer back, and finally DNS resolver 127 sends the answer back to user.

The anti-DDOS products can be used to protect the DNS resolver 127, the authoritative DNS server 138, or other devices.

The transparent proxy is a TCP proxy, which plays as a middle man representing server to establish TCP connection with client side. The “transparent” means this kind of TCP proxy does not need an IP address configured on proxy node. It just acts like a “wire”, client side cannot aware of its existence. Typically, anti-DDOS appliance is deployed as a layer 2 device (like 12 switch), there is no any IP configuration on layer 2 anti-DDOS appliance, so the transparent TCP proxy can work well on anti-DDOS appliance.

One embodiment of a main data flow of the proxy mode authentication method is as follow:
Step 1: Challenge: at DDOS mitigation network appliance 119, an anti-DDOS appliance, here as an example), when receive UDP DNS query, DDOS mitigation network appliance 119 will challenge the client with a DNS response with TC bit set 1, so if the client is a normal one, then it should transfer its DNS query process to TCP protocol, and resend its DNS query over TCP, this is the expected action for normal client, or it will fail to do this and auth failed.
Step 2: Transparent proxy: if the client successfully send back with TCP SYN, then the FDD-F will do the transparent proxy, it pretends to be the real DNS server, and establish TCP connection with client.
Step 3: Authentication judgement: if the client successfully establish TCP connection with DDOS mitigation network appliance 119 (finish the three-handshake process successfully), normally it can be consider client successfully pass the authentication, proved it is a real and normal client, not a bot.
Step 4: the client then should send its DNS query again over TCP, but DDOS mitigation network appliance 119 will generate a UDP DNS query for it and get the DNS answers from the real DNS server; so from real DNS server's view, it just received a UDP DNS query from client, it does not need to aware of the TCP processing, the real DNS server no need to support DNS over TCP. This eliminates the biggest drawbacks of active TCP method has.
Step 5: after send the DNS answer to client, the DDOS mitigation network appliance 119 can close the TCP connection gracefully.

FIG. 1C is a more detailed block diagram illustrating the DDOS mitigation network appliance 119 of the system of FIG. 1, according to one embodiment. The components can be implemented in hardware, software, or a combination of both.

A DNS query module 209 receives a UDP DNS query from a client. A TCP module 219 challenges the client by sending back a DNS response with a Truncated (TC) bit set to 1. The TCP module 219, responsive to the client sending back a TCP SYN frame, can attempt to establish a TCP connection with the client from the transparent DNS proxy. The DNS query module 209, responsive to a successful TCP connection, forwards the UDP DNS query from the transparent DNS proxy to the DNS resolver on behalf of the client. The TCP module 219, responsive to receiving a DNS response from the DNS resolver can convert the UDP DNS response to a TCP response forwarded to the client and then closes the TCP connection. Other variations are possible.

The network communication module 230 outputs the data traffic of the first data packet and subsequent data packets of the first session to the selected SDWAN route.

### II. Methods for Transparent Proxy DDOS Mitigation

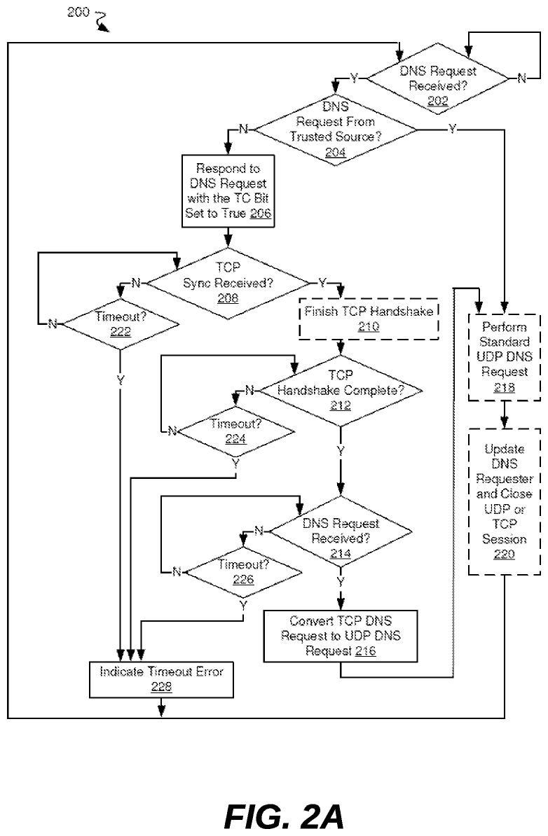

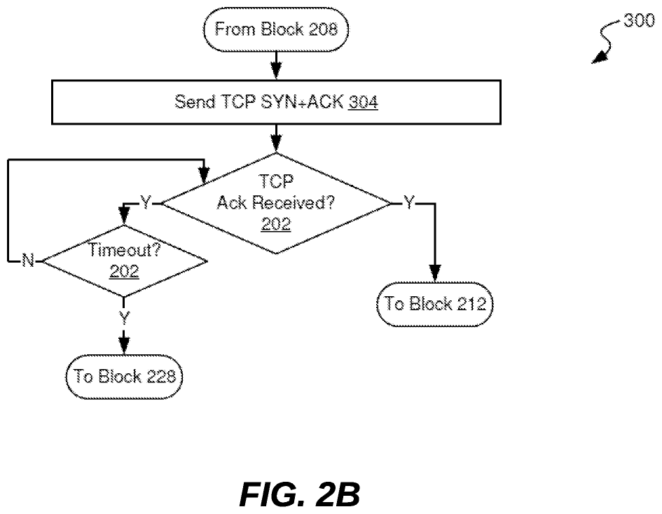

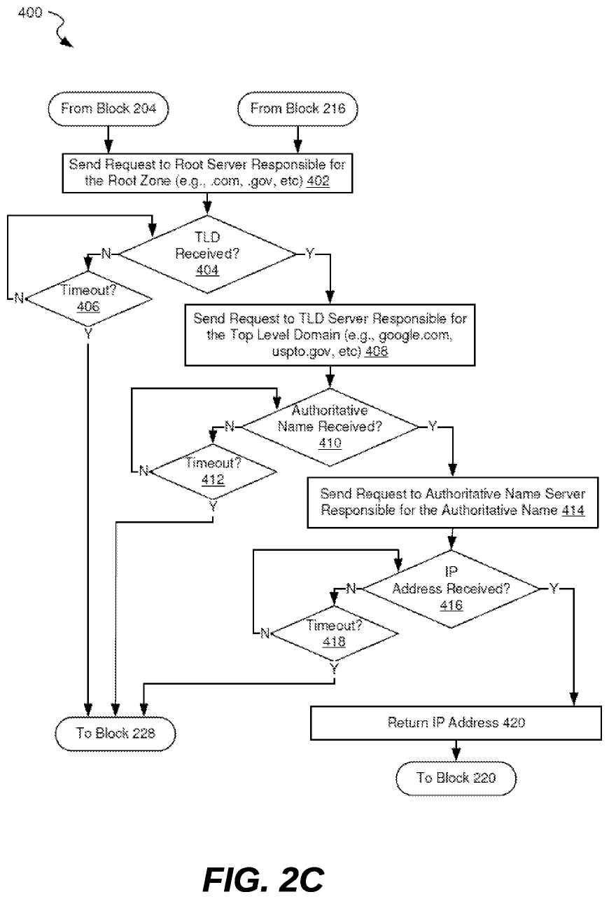

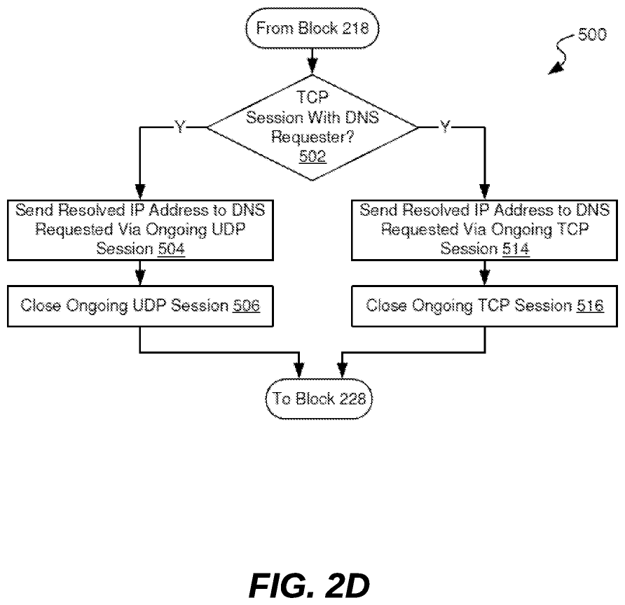

FIG. 2A is a high-level flow diagram illustrating a method for protecting against DDOS attacks on a DNS resolver from a client without notification to the DNS resolver to the client, according to an embodiment. A DNS request is received (Step 202), and if from a trusted source, the standard UDP DNS request process is performed (step 218) and a DNS requester is updated and session is closed (step 220).

However, if not received from a trusted source, a DNS response is sent with the TC bit set to true (step 206). As a result, a non-script is capable of sending a TCP SYN (step 208) and if further capable of establishing a TCP session with a TCP handshake (step 210, 212), the transparent proxy completes the request on behalf of the client. In more detail, the DNS is now forwarded to a DNS resolver for service as if the transparent proxy never intercepted the DNS request (step 214, 216).

In some cases, the process is interrupted with timeouts (Steps 222, 224, 226, 228).

FIG. 2B is a more detailed flow diagram illustrating a step 210 for finishing TCP handshake, from the method of FIG. 2A, according to one embodiment. Here, a TCP SYN+ACK is sent (step 304) and then a TCP ack is received (step 202).

FIG. 2C is a more detailed flow diagram illustrating a step for performing standard a UDP DNS request, from the method of FIG. 2A, according to one embodiment. A request is sent to Root Server responsible for Root Zone (step 402). When a TLD is received (step 404), a request is sent to an authoritative name server responsible for the authoritative name (step 414). Once the IP address is received (step 416), it is returned (Step 42), before the process returns to step 220.

FIG. 2D is a more detailed flow diagram illustrating a step for updating DNS requester and close a UDP or TCP session, from the method of FIG. 2, according to one embodiment. A TCP session with DNS requester (step 502) sends resolved IP addresses to DNS requested via outgoing UDP session (step 504) and via outgoing TCP session (Step 514). Then the sessions are closed (step 506, 516) before returning to step 220. Timeouts can interrupt the process back to step 228 (steps 406, 412, 418).

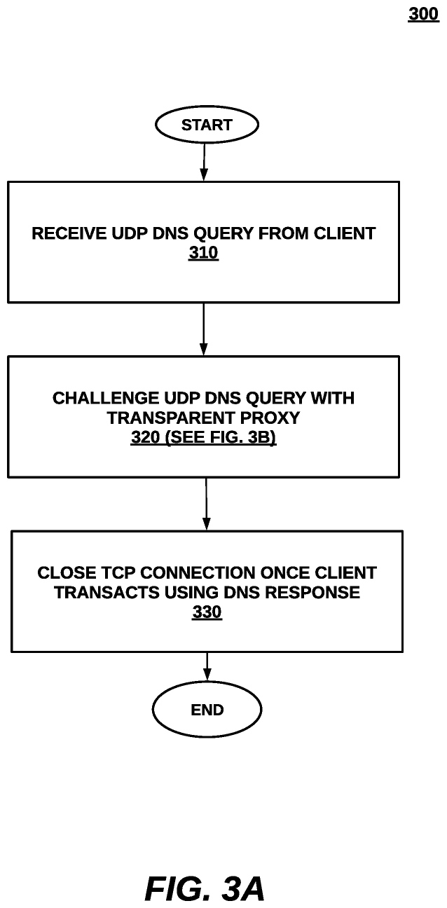

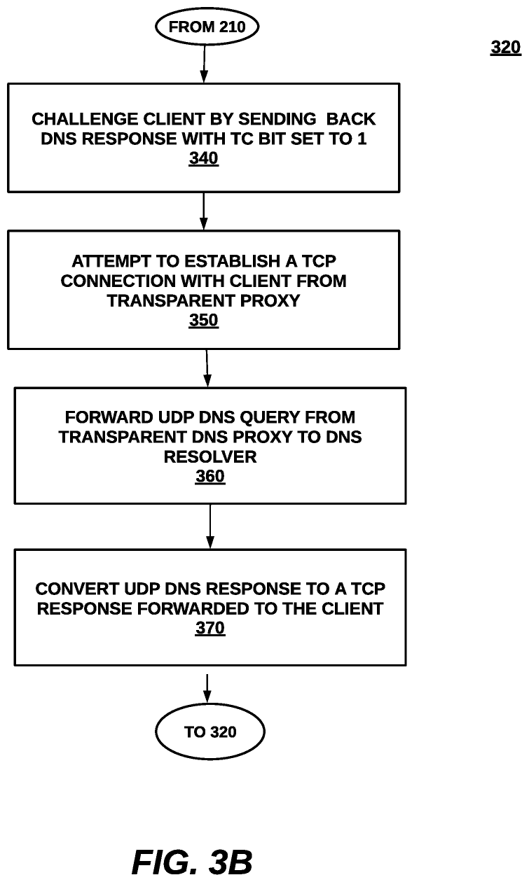

FIG. 3A is a high-level flow diagram of a method 400 for load balancing data traffic, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 210, a UDP DNS query is received from a client. At step 220, a transparent proxy (e.g., DDOS mitigation network appliance 119) challenges the DNS query for malicious scripts over TCP, as described with respect to FIGS. 2B-D below. At step 230, once the client transacts over the network using information from the DNS response, the TCP connection is closed.

FIG. 3B is a more detailed flow diagram detailing the step 220 of per-application SD-WAN path selection, during loading balancing, utilizing TOS, according to an embodiment.

Specifically, at step 340, the client is challenged by sending back a DNS response with a Truncated (TC) bit set to 1.

At step 350, responsive to the client sending back a TCP SYN frame, an attempt is made to establish a TCP connection with the client from the transparent DNS proxy.

At step 360, responsive to a successful TCP connection, the UDP DNS query is forwarded from the transparent DNS proxy to the DNS resolver on behalf of the client.

At step 370, responsive to receiving a DNS response from the DNS resolver, the UDP DNS response can be converted to a TCP response forwarded to the client. Then step 220 returns to step 230, ultimately closing the TCP connection.

### III. Computing Device for Transparent Proxy DDOS Mitigation

FIG. 1D is a block diagram illustrating a computing device 600 for use in the system 100 of FIG. 1A, according to one embodiment. The computing device 600 is a non-limiting example device for implementing each of the components of the system 100, including the network devices 116a-d, 106a-b, DDOS mitigation network appliance 119, the DNS resolver 127, the root server 130, the top level domain server 134 and the authoritative name server 138. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a transparent DNS proxy on a data communication network, for protecting against DDOS attacks on a DNS resolver from a client without notification to the DNS resolver to the client, the method comprising:
receiving a UDP DNS query from a client;
challenging the client by sending back a DNS response with a Truncated (TC) bit set to 1;
responsive to the client sending back a TCP SYN frame, attempting to establish a TCP connection with the client from the transparent DNS proxy;
responsive to a successful TCP connection, forwarding the UDP DNS query from the transparent DNS proxy to the DNS resolver on behalf of the client;
responsive to receiving a DNS response from the DNS resolver, converting the UDP DNS response to a TCP response forwarded to the client; and
closing the TCP connection.

2. The method of claim 1, further comprising configuring rules associated with selecting links for sessions.

3. The method of claim 1, wherein the TOS parameters comprise a TOS field.

4. The method of claim 1, wherein the step of selecting the SD-WAN route further comprises overriding a first selected SD-WAN route if one of the links of the route are unreachable.

5. The method of claim 1, wherein the step of selecting the SD-WAN route further comprises overriding a first selected SD-WAN route if a security check of the route does not pass.

6. The method of claim 1, wherein SD-WAN links comprise one or more of Internet, LTE, mobile data, cell data, ADSL, Wi-Fi, and Ethernet.

7. A non-transitory computer-readable medium in a SD-WAN server on a data communication network, for protecting against DDOS attacks on a DNS resolver from a client without notification to the DNS resolver to the client, the method comprising:
receiving a UDP DNS query from a client;
challenging the client by sending back a DNS response with a Truncated (TC) bit set to 1;
responsive to the client sending back a TCP SYN frame, attempting to establish a TCP connection with the client from the transparent DNS proxy;
responsive to a successful TCP connection, forwarding the UDP DNS query from the transparent DNS proxy to the DNS resolver on behalf of the client;
responsive to receiving a DNS response from the DNS resolver, converting the UDP DNS response to a TCP response forwarded to the client; and
closing the TCP connection.

8. A Software-Defined Wide Area Network (SD-WAN) server on a data communication network, for protecting against DDOS attacks on a DNS resolver from a client without notification to the DNS resolver to the client, the SD-WAN server comprising:
a processor;
a network interface communicatively coupled to the processor and to a data communication network; and
a memory, communicatively coupled to the processor and storing:
a first module to receive a UDP DNS query from a client;
a second module to challenge the client by sending back a DNS response with a Truncated (TC) bit set to 1;
a third module to, responsive to the client sending back a TCP SYN frame, attempt to establish a TCP connection with the client from the transparent DNS proxy;
a fourth module to, responsive to a successful TCP connection, forward the UDP DNS query from the transparent DNS proxy to the DNS resolver on behalf of the client;
a fifth module to, responsive to receiving a DNS response from the DNS resolver, convert the UDP DNS response to a TCP response forwarded to the client,
wherein the third module closes the TCP connection.
